(19) United States
(12) Patent Application Publication
(10) Pub. No.: US 2005/0196660 A1
(43) Pub. Date: Sep. 8, 2005

(54) Method for measuring water distribution between conductive members, cell for measuring water distribution in polymer membrane and apparatus for measuring water distribution in polymer membrane

(75) Inventors: Shohji Tsushima, Yokohama (JP); Shuichiro Hirai, Ohta-ku (JP); Katsuhiko Fukuzato, Nerima-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: THE CIRCLE FOR THE PROMOTION OF SCIENCE AND ENG, Tokyo (JP); SEIKA CORPORATION, Tokyo (JP)

(21) Appl. No.: 11/085,521

(22) Filed: Mar. 22, 2005

(30) Foreign Application Priority Data
Nov. 21, 2002 (JP) 2002-337761

(51) Int. Cl. H01M 2/00

(52) U.S. Cl. 429/34

(57) ABSTRACT

A method for measuring a water distribution between two platy conductive members that are arranged so as to face each other by using a MRI apparatus includes a step of measuring the water distribution between the two platy conductive members by irradiating the water by an electromagnetic wave along a direction which a gap formed by the two platy conductive members spreads.

We claim this application being incorporated with Japanese patent application No. 2002-337761 filed on Nov. 21, 2002 to the Japan Patent Office.

### BACKGROUND OF THE INVENTION

The present invention relates generally a method for measuring a water distribution between conductive members, a cell for measuring a water distribution in a polymer membrane and an apparatus for measuring a water distribution in a polymer membrane, particularly relates things that can measure a water distribution between electrically conductive members.

A polymer is a chemical compound which includes a molecular weight of ten thousand or more. Many functional polymers having various functions are well known. A polymer membrane as one of the functional polymers has a large surface area in comparison with its thickness. The electrochemistry potential difference existing between materials located each side of the polymer membrane generates various membrane phenomena such as a membrane potential, an electro-osmosis, a volume flux, a thermal-osmosis. The membrane phenomena are induced by the diffusion velocity difference of materials that pass through the polymer membrane.

Recently, a polymer membrane having permeability is used for a fuel cell. The fuel cell that uses the polymer membrane is called as a polymer electrolyte fuel cell (PEFC) and is also called as a solid polymer type fuel cell. The polymer membrane provided to the PEFC is called as a polymer electrolyte membrane (PEM) . The PEFC is expected to be able to act in relatively low temperature as 80-100 centigrade and obtain relatively high power generation efficiency in comparison with other type of the fuel cell such as a Solid Oxide Fuel Cell (SOFC) . Therefore, the PEFC is suitable for the power supply of cars and homes, and it attracts a great deal of public attention.

The PEFC generally includes fuel cell stacks which are composed by lamination of the units called as single cells. Each single cell includes a membrane electrode assembly (MEA) and separators that hold each side of the MEA and have supply channel for hydrogen or oxygen. The MEA includes the platy PEM and gas diffusion electrodes (a fuel electrode and an air electrode) that hold each side of the PEM.

The hydrogen is electrolyzed into the hydrogen ion and the electron at the fuel electrode in power generating by the PEFC. The electron moves to the air electrode via the external circuit. While, the hydrogen ion moves to the air electrode by penetrating the PEM and composes the water by reacting with the oxygen and the electron at the air electrode.

The hydrogen ion hydrates with water in the PEM. Therefore, the water molecule hydrated with the hydrogen ion moves to the air electrode with the hydrogen ion that moves from the fuel electrode to the air electrode in power generating. Additionally, as the water is produced by the reaction at the air electrode, the water distribution in the PEM is supposed to be uneven. The water is thought to be diffused toward the fuel electrode by the unevenness of the water distribution. Furthermore, the water is thought to be evaporated to outside of the PEM by the heat generation in the power generation.

The PEM should be wet appropriately for the movement of the hydrogen ion in the PEM from the fuel electrode to the air electrode. As the movement of the hydrogen ion in the PEM greatly depends on the water containing state of the PEM, the electric resistance of the PEM will increase and the movement of the hydrogen ion will be lowered in accordance with drying of the PEM.

Therefore, to maintain the PEM appropriately wet, the water is generally controlled by moistening the hydrogen or the oxygen which is supplied to the PEM.

Thus, the water distribution in the PEM of the PEFC and the mechanism of the water movement change variously in accordance with the state of the PEM. Therefore, elucidation of the water moving mechanism in the PEM is the important key to maintain the output power of the PEFC high and stable. While, the material of the PEM has to be developed to improve the performance of the PEFC. The development of the PEM material is necessary simultaneously with the elucidation of the water moving mechanism.

In the PEFC previously described, the method for estimating the water state of the PEM by monitoring the resistance values of whole the PEM by using impedance method is well known as the conventional method for measuring the water distribution in the PEM that is held by conductive electrodes in generating power (see Refs. 1 and 2).

Additionally, the method for measuring water state of the PEM from the intensity of the neutron laser that passes through the PEM by emitting the laser to the PEM is also well known (see Ref. 3)

Reference 1:

B. Andreaus, A. J. McEvoy, and G. G. Scherer; Analysis of performance losses in polymer electrolyte fuel cells at high current densities by impedance spectroscopy, ElectrochimicaActa, U.K., Elsevier Science Ltd., 2002, vol.47, p.2223-2229

Reference 2:

T. J. P. Freire and E. R. Gonzalez; Effect of membrane characteristics and humidification conditions of the impedance response of polymer electrolyte fuel cells, Journal of Electroanalytical Chemistry, Switzerland, Elsevier Science Ltd., 2001, vol. 501, p. 57-68

Reference 3:

R. J. Bellows, M. Y. Lin, M. Arif, A. K. Thompson, and D. Jacobson; Neutron Imaging Technique for In Situ Measurement of Water Transport Gradients within Nafion in Polymer Electrolyte Fuel Cells, Journal of The Electrochemical Society, USA, The Electrochemical Society Inc., 1999, vol. 146, 3rd edition, p. 1099-1103

However, only the information of whole the PEM can be obtained from the technology disclosed in Refs. 1 and 2. Therefore, they have a problem that it is difficult to measure clearly the change of the wetness in the PEM at the sides of the air electrode and the fuel electrode, i.e., the water distribution in the PEM.

The technology disclosed in Ref. 3 can only obtain the information of the water distribution linearly. Therefore, it has a problem that it is difficult to measure the water distribution in the PEM spatially.

### BRIEF SUMMARY OF THE INVENTION

Accordingly, it is an exemplary object to provide a method for measuring a water distribution between electrically conductive elements, a cell for measuring a water distribution in a PEM, and an apparatus for measuring a water distribution in a PEM.

In order to achieve the above object, a method according to one aspect of the present invention for measuring a water distribution between two platy conductive members that are arranged so as to face each other by using a MRI apparatus includes a step of measuring the water distribution between the two platy conductive members by irradiating the water by an electromagnetic wave along a direction which a gap formed by the two platy conductive members spreads.

Here, the “MRI apparatus” includes a static magnetic field generator for generating a static magnetic field, a gradient magnetic field generator for generating a gradient magnetic field, an electromagnetic wave emitter for emitting an electromagnetic wave, an electromagnetic wave detector for detecting an electromagnetic wave, a converter for converting the detected electromagnetic wave to an electric signal, an image processor for processing an image according to the electric signal. The “MRI image” includes a graph that is according to the electric signal.

The “conductive members that are arranged so as to face each other” includes the platy two approximately parallel-arranged conductive members besides the platy two precisely parallel-arranged conductive members. The “conductive member” means the element using a material which the high frequency electromagnetic wave cannot penetrate. The conductive member is, for example, an electrode that includes copper or platinum.

According to the method for measuring the water distribution between the conductive members, the water distribution between the conductive members can be measured spatially (3-dimensionally) by emitting the electromagnetic wave to the hydrogen molecular of the water along the direction which the gap formed by the conductive members spreads.

The directions of the staticmagnetic field and the gradient magnetic field which are applied by the MRI apparatus should be along the direction which the gap formed by the conductive members spreads. For example, the “gradient magnetic field in the direction of the X-axis” means the magnetic field whose direction is the same as the direction of the static magnetic field, and the slope of the gradient magnetic field's intensity slants along the direction of the X-axis.

The irradiation direction of the electromagnetic wave is preferably perpendicular to the direction of the above-mentioned static magnetic field. That is, the irradiation direction of the electromagnetic wave is preferably perpendicular to the above-mentioned static magnetic field in the plane parallel to the surfaces of the platy conductive members.

A cell according to another aspect of the present invention for measuring a water distribution in a polymer membrane, which is applied to a MRI apparatus includes a platy polymer membrane that contains a water, conductive members that hold each side of the polymer membrane, an electromagnetic wave induction member that is arranged adjacently to the polymer membrane and can be passed by an electromagnetic wave emitted from outside through to the polymer membrane, and an electromagnetic wave derivation member that is arranged adjacently to the polymer membrane and can be passed by an electromagnetic wave radiated from the polymer membrane after the emission through to outside.

Here, the “electromagnetic wave induction member that can be passed by an electromagnetic wave” means the electromagnetic wave induction member uses a material that has a character of being penetratable by the electromagnetic wave. That is, the electromagnetic wave induction member should have low conductivity, and uses at least one selected from, for example, the group of silicon rubber or polytetrafluoroethylene (PTFE). The electromagnetic derivation member should be the same structure as the electromagnetic induction member.

The cell for measuring the water distribution in the PEM can make hydrogen of the water in the PEM resonate with the electromagnetic wave in accordance with the reach of the electromagnetic wave from outside into the inside of the PEM by passing through the electromagnetic induction member by installing the cell for measuring the water distribution in the PEM in an appropriate direction to the electromagnetic wave emitted from the electromagnetic wave emitter that includes such as a RF coil of the MRI apparatus. After the emission of the electromagnetic wave from outside to the PEM, the electromagnetic wave radiated from the resonant hydrogen is delivered to outside via the electromagnetic derivation member and is detected by the electromagnetic wave detector that includes such as the RF coil of the MRI apparatus. Thus, the water distribution in the PEM can be measured.

The electromagnetic wave induction member should be adjacent to at least a part of the sidewall of the PEM along the surface direction of the platy PEM, and at least a part of the electromagnetic induction member should be exposed in the surface of the cell for measuring the water distribution in the PEM. The electromagnetic derivation member should be the same structure as the electromagnetic induction member. The electromagnetic wave induction member and the electromagnetic derivation member may be substantially the same materials that have both functions.

A cell of another aspect of the present invention for measuring a water distribution in a polymer membrane is applied to a MRI apparatus and includes a platy polymer membrane that contains a water, and conductive members that hold each side of the polymer membrane. Here at least a part of a sidewall of the polymer membrane is exposed to outside, an electromagnetic wave emitted from outside can reach inside of the polymer membrane by entering from the part of the sidewall, and an electromagnetic wave is radiated from the polymer membrane after the emission toward outside through the part of the sidewall.

The cell for measuring the water distribution in the PEM can make hydrogen of the water in the PEM resonate with the electromagnetic wave in accordance with the reach of the electromagnetic wave from outside into the inside of the PEM by installing the exposed part of the sidewall of the PEM in an appropriate direction to the irradiation direction of the electromagnetic wave emitted from the electromagnetic wave emitter that includes such as a RF coil of the MRI apparatus. After the emission of the electromagnetic wave to the PEM, the electromagnetic wave radiated from the hydrogen is radiated to outside via the exposed part of the PEM's sidewall and is detected by the electromagnetic wave detector that includes such as the RF coil of the MRI apparatus. Thus, the water distribution in the PEM can be measured.

By providing diffusion members that have a plurality of through holes to both sides of the PEM, a liquid from outside can be supplied to the PEM with dispersion via the plurality of the through holes in the cell for measuring the water distribution.

Here, “via the plurality of the through holes” means “via all the plurality of the holes” or “via some of the plurality of the holes”.

According to the cell for measuring the water distribution in the PEM, the liquid is supplied with dispersion to the PEM via the plurality of the through holes of the diffusion members. Therefore, the concentration distribution (i.e., the distribution caused by the unevenness of the concentration) of the liquid is hardly produced in the direction of the PEM's surface and the water distribution in the PEM will be measured suitably.

A referential polymer membrane that uses the same material as the PEM may be provided to the polymer membrane cell.

According to the cell for measuring the water distribution in the PEM, detecting and comparing the electromagnetic waves that passes through the PEM and the referential polymer membrane can measure the water distribution in the PEM in measuring the water distribution in the PEM by installing the cell to the MRI apparatus.

An apparatus of still another aspect of the present invention for measuring a water distribution in a polymer membrane includes a polymer membrane cell for measuring the water distribution being applied to a MRI apparatus, which includes a platy polymer membrane that contains a water, conductive members that hold each side of the polymer membrane, an electromagnetic wave induction member that is arranged adjacently to the polymer membrane and can be passed by an electromagnetic wave emitted from outside through to the polymer membrane, and an electromagnetic wave derivation member that is arranged adjacently to the polymer membrane and can be passed by an electromagnetic wave radiated from the polymer membrane after the emission through to outside. The apparatus for measuring the water distribution in a polymer membrane further includes a static magnetic field generator that generates a static magnetic field and applies the static magnetic field to the polymer membrane, a gradient magnetic field generator that generates a gradient magnetic field and applies the gradient magnetic field to the polymer membrane, an electromagnetic wave emitter to emit an electromagnetic wave to the polymer membrane, an electromagnetic wave detector to detect a electromagnetic wave radiated from the polymer membrane after the emission, a converter to convert the detected electromagnetic wave to an electric signal; and an image processor to process an image according to the electric signal. The polymer membrane cell for measuring the water distribution is arranged along both directions that the electromagnetic wave emitted from the electromagnetic wave emitter can reach to the polymer membrane and the electromagnetic wave radiated from the polymer membrane can reach to the electromagnetic wave detector.

The apparatus for measuring the water distribution in the polymer membrane can apply the static magnetic field and the gradient magnetic field in the water in the polymer membrane, emit the electromagnetic wave, and make the hydrogen in the water be resonant. And after emitting the electromagnetic wave, the apparatus for measuring the water distribution in the polymer membrane can detect the electromagnetic wave radiated from the resonant hydrogen by the electromagnetic wave detector, convert the electromagnetic wave to the electric signal. The apparatus for measuring the water distribution in the polymer membrane can further generate and output an MRI image according to the electric signal, and the operator of the apparatus can recognize the water distribution in the polymer membrane in view.

Here, the electromagnetic wave emitter and the electromagnetic wave detector may be substantially the same unit. That is, the unit may have the function for generating the electromagnetic wave when emitting the electromagnetic wave, and also have the function for detecting the electromagnetic wave when detecting the electromagnetic wave.

Other objects and further features of the present invention will become readily apparent from the following description of the preferred embodiments with reference to the accompanying drawings.

### BRIEF DESCRIPTION OF THE DRAWINGS

FIG. 1 is a view for explaining the method for measuring the water distribution between the conductive members of the first embodiment according to the present invention.

FIG. 2 is a schematic view of the MRI image that is obtained by the method for measuring the water distribution between the conductive members shown in FIG. 1. FIG. 2A shows the case where α=90°, FIG. 2B shows the case where α=60, FIG. 2C shows the case where α=30°, and FIG. 2D shows the case where α=10°,wherein a is the irradiation angle of the electromagnetic wave emitted from the RF coil.

FIG. 3 is an exploded perspective view of the cell 10 for measuring the water distribution in the polymer membrane of the second embodiment according to the present invention.

FIG. 4 is a general view showing the arrangement of the apparatus 100 for measuring the water distribution in the polymer membrane of the third embodiment according to the present invention.

FIGS. 5A and 5B are perspective views showing the principle part of the apparatus 100 for measuring the water distribution in the polymer membrane of the third embodiment shown in FIG. 4.

FIG. 6 is a X-X′ sectional view of the principle part of the apparatus 100 for measuring the water distribution in the polymer membrane of the third embodiment shown in FIG. 5A.

FIG. 7 is a view explaining the state of the water distribution in the polymer membrane measured by the apparatus 100 for measuring the water distribution in the polymer membrane of the third embodiment.

FIG. 8A is a schematic view showing the aging change of the MRI image of the polymer electrolyte membrane (polymer membrane). FIG. 8B is a graph showing the aging change of the current that runs in the external circuit of the apparatus 100 for measuring the water distribution in the polymer membrane in accordance with the aging change shown in FIG. 8A.

FIG. 9A is a schematic view showing the MRI images of the polymer electrolyte membrane (polymer membrane) and the referential polymer electrolyte membrane (referential polymer membrane) before generating the power and on generating the power. FIG. 9B is a graph showing the MRI signal intensity vs. water content of the polymer electrolyte membrane (polymer membrane) and the referential polymer electrolyte membrane (referential polymer membrane).

FIG. 10A is a schematic view of the MRI image of the polymer electrolyte membrane M. FIG. 10B is a graph showing the number of the water molecules per a sulfonic acid radical in the thickness direction of the polymer electrolyte membrane M.

### DETAILED DESCRIPTION OF THE PREFERRED EMBODIMENTS

Referring now to the accompanying drawings, descriptions will be now given of the embodiments according to the present invention. The first embodiment explains a method for measuring a water distribution between conduction members according to the present invention. The second embodiment explains a cell for measuring the water distribution in a polymer membrane according to the present invention which is applied to a membrane electrode assembly (MEA) of a polymer electrolyte fuel cell (PEFC) The third embodiment explains an apparatus for measuring the water distribution in a polymer electrolyte membrane (polymer membrane) of the membrane electrode assembly explained in the second embodiment. The same element explained in each embodiment uses the same reference numeral and the description will be omitted.

[The First Embodiment]

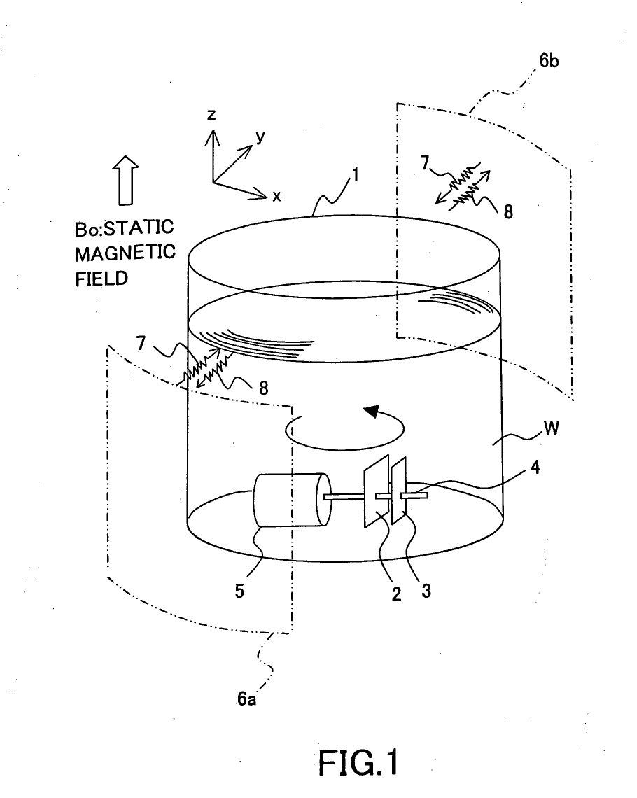

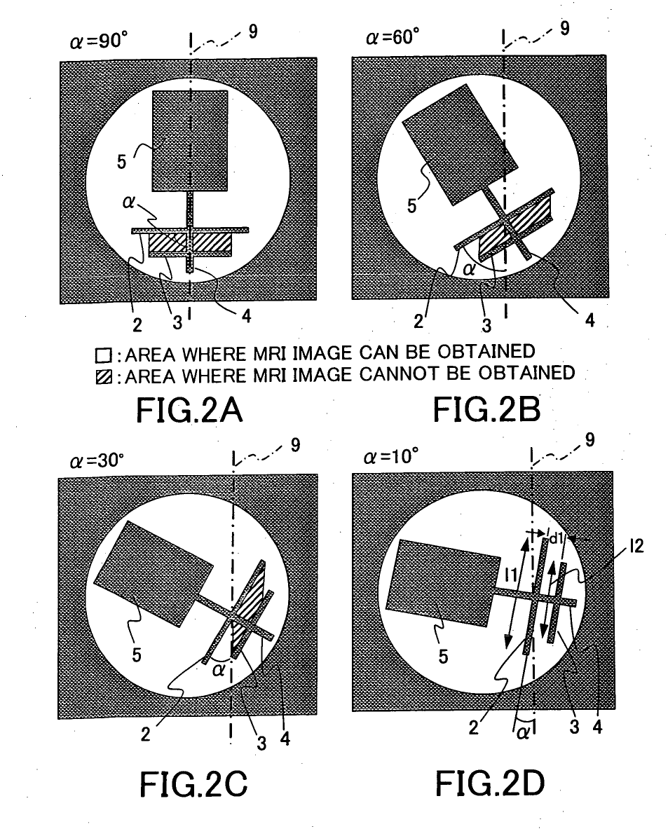

Referring to FIGS. 1 and 2, a description will be now given of a method for measuring the water distribution of the first embodiment according to the present invention. FIG. 1 is a view for explaining the method for measuring the water distribution between the conductive members of the first embodiment. FIG. 2 is a schematic view of the MRI image that is obtained by the method for measuring the water distribution between the conductive members shown in FIG. 1. FIG. 2A shows the case where α=90°, FIG. 2B shows the case where α=60°, FIG. 2C shows the case where α=30°, and FIG. 2D shows the case where α=10°, wherein a is the irradiation angle of the electromagnetic wave emitted from the RF coil.

The method for measuring the water distribution according to the first embodiment can be processed by installing a container 1 being filled with water W to a MRI apparatus which includes facing RF coils 6a and 6b (generally called as “saddle coils”). The x, y and z axes being perpendicular to each other are shown in FIG. 1.

The RF coils 6a and 6b are provided in a measuring part of the MRI apparatus. A static magnetic field generating coil and a gradient magnetic field generating coil (both are not shown) are provided in the measuring part.

The RF coils 6a and 6b (the electromagnetic wave emitters) are facing each other, and can emit electromagnetic waves 7 and 7 along the y-direction shown in FIG. 1. And the RF coils 6a and 6b, as electromagnetic wave detectors, can detect electromagnetic waves 8 and 8 (also called as “signals”) radiated from resonant hydrogen of the water W after emitting the electromagnetic waves 7 and 7, and can convert the electromagnetic waves 8 and 8 to MRI signals (also called as “NMR signal”). According to the electric signals, an image processor such as a microcomputer (not shown) outputs the MRI image. Here, the MRI signals are corresponds to the electric signals.

The static magnetic field generating coi; (not shown) can generates static magnetic field Bo along the Z-direction. That is, the direction of the static magnetic field Bo (z-direction) is perpendicular to the direction of the electromagnetic waves 7 and 7 (y-direction) emitted from the RF coils 6a and 6b.

The gradient magnetic field generating coil (not shown) includes a x-direction gradient magnetic field generating coil (not shown), a y-direction gradient magnetic field generating coil (not shown), and a z-direction gradient magnetic field generating coil (not shown). The coils can generate the gradient magnetic fields graded along the x-direction, the y-direction, and the z-direction shown in FIG. 1 respectively.

The container 1 has a bottom and a cylindrical shape, and uses non-conductive material such as acrylic resin. The container 1 is located in the middle between the RF coils 6a and 6b.

The container 1 reserves the water W in itself, and two platy carbon electrodes 2 and 3 are arranged in standing and parallel with a specific distance from each other at the bottom of the container 1.

The carbon electrodes 2 and 3 (the conductive members) are platy and conductive with having platinum on their surfaces and arranged in parallel with a specific distance from each other. Therefore, the electromagnetic wave 7 and 7 emitted from the RF coils 6a and 6b cannot pass through the carbon electrodes 2 and 3.

The conductive members use the carbon electrodes 2 and 3 which have platinum on their surfaces in the first embodiment. However, the conductive members are not limited so, and can use one suitably selected from well-known conductive materials.

The length 11 of the carbon electrode 2 in the horizontal direction (the y-direction) is 15 mm, the length 12 of the carbon electrode 3 in the horizontal direction (the y-direction) is 10 mm, and the distance dl between two carbon electrodes is 1 mm in the first embodiment. However, they are not limited so, and can be other suitable sizes.

Still, numeral reference 4 indicates a support rod to support the carbon electrodes 2 and 3 with a specific distance. Numeral reference 5 indicates a rubber weight to sink the carbon electrodes 2 and 3 into the bottom of the container 1.

In the arrange state explained above, the static magnetic field Bo is applied to the container 1 reserving the water W in the z-direction, the gradient magnetic field is applied to the same in the x, y and z-directions, the electromagnetic waves 7 and 7 are emitted from the RF coils 6a and 6b to the hydrogen of the water W along the y-direction (i.e., along the direction which the gap formed by the platy carbon electrodes 2 and 3 spreads) and make the hydrogen of the water W resonant in the state, while the positional information of 3-dimensional direction (x-direction, y-direction and z-direction) is given to the hydrogen of the water W. After emitting the electromagnetic waves 7 and 7, the electromagnetic waves 8 and 8 radiated from the resonant hydrogen are detected by the RF coils 6a and 6b, are converted to the electric signal. The image processor not shown (such as the microcomputer) process the electric signal and the MRI image sectioned at any plane in 3-dimensinal directions can be obtained. Thus, the distribution of the hydrogen (i.e., the distribution of the water W) can be measured.

By rotating the carbon electrodes 2 and 3 as shown in FIG. 1, the measurement is carried out with changing the irradiation angle a formed by the electromagnetic waves 7 and 7 emitted from the RF coils 6a and 6b and the carbon electrodes 2 and 3 in the first embodiment.

Following description with referring to FIG. 2 is a result obtained by the method for measuring the water distribution according to the first embodiment. FIG. 2A to 2D are a schematic view of the MRI image of the container 1 sectioned by the plane which includes the support rod 4.

In the case where the irradiation angle α=90°, the area where the MRI image cannot be obtained (the 45 hatching area in FIG. 2A) is detected between the carbon electrodes 2 and 3 as shown in FIG. 2A. The electromagnetic waves 7 and 7 emitted from the RF coils 6a and 6b are thought to be unreachable to the area because of being shielded by the carbon electrodes 2 and 3.

In accordance with the decrease of the irradiation angle a to 60° (see FIG. 2B) or 30° (see FIG. 2C), the area where the MRI image can not be obtained becomes small. The reason is thought that the area of the carbon electrodes 2 and 3 that shield the electromagnetic wave 7 in the electromagnetic wave emitting direction 9 becomes small.

In the case where the irradiation angle α=10°, the MRI image can be obtained at anywhere between the carbon electrodes 2 and 3 as shown in FIG. 2D.

That is, the electromagnetic waves 7 and 7 can reach to the area between the carbon electrodes 2 and 3 by rotating the carbon electrodes 2 and 3 to the electromagnetic wave emitting direction 9, arranging the irradiation angle a appropriately, and emitting the electromagnetic waves 7 and 7 from the RF coils 6a and 6b along the direction which the gap formed by the platy carbon electrodes 2 and 3 spreads.

After the resonance of the hydrogen of the water W between the carbon electrodes 2 and 3, the electromagnetic waves 8 and 8 radiated from the resonant hydrogen are detected by the RF coils 6a and 6b, are converted to the electric signals, and the distribution of the water W between the carbon electrodes 2 and 3 can be analyzed according to the MRI image obtained by the electric signals.

Still, a person skilled in the art can easily understand the measurement can be processed more appropriately in the case where the irradiation angle a will be 10° or smaller.

The RF coils 6a and 6b may be rotated to adjust the irradiation angle a instead of the rotation of the carbon electrodes 2 and 3 described in the first embodiment.

In the first embodiment, the electromagnetic waves can reach to the water between the carbon electrodes 2 and 3 when the length 11 of the carbon electrode 2 is 15 mm, the length 12 of the carbon electrode 3 is 10 mm, the distance of the two carbon electrodes is 1 mm, and their radiation angle α is 10°. However, the measurement of the water distribution between the conductive members can obviously be processed by setting the carbon electrode's length or distance on another appropriate sizes.

As previously explained, the electromagnetic wave can reach to the gap between the conductive members which the electromagnetic wave cannot penetrate by generating the static magnetic field and the gradient magnetic field, applying the same to the water between the conductive members, adjusting the irradiation angle α of the electromagnetic wave appropriately, and emitting the electromagnetic wave. The water distribution between the conductive members can be measured by making the hydrogen of the water be resonant, detecting the electromagnetic wave radiated from the hydrogen in settling to the stable state after the emission, converting the electromagnetic wave to the electric signal, and obtaining the MRI image that is analyzed in accordance with the electric signal.

[The Second Embodiment]

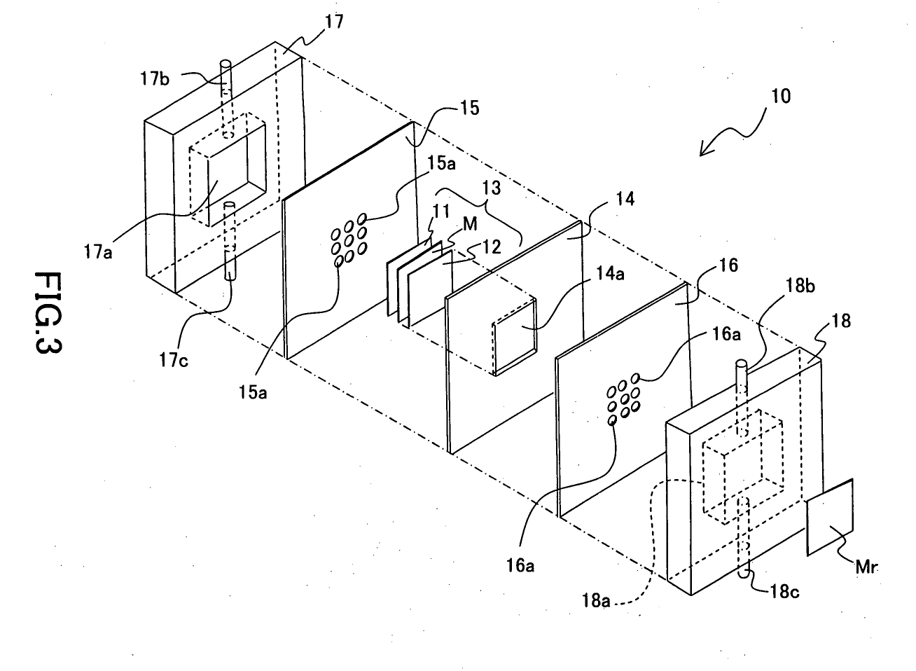

The description will be given of a cell 10 for measuring the water distribution in the polymer membrane of the second embodiment according to the present invention with referring FIG. 3.

As shown in FIG. 3, the cell 10 for measuring the water distribution in the polymer membrane includes a membrane electrode assembly (MEA) 13, an induction and derivation member 14 of the electromagnetic wave having a through hole 14a for inserting the MEA 13, current collectors 15 and 16 to hold both outsides of the induction and derivation member 13 of the electromagnetic wave, housings 17 and 18 to hold outside of the current collectors 15 and 16 respectively, and a referential polymer electrolyte membrane (referential PEM) Mr arranged at outside of the housing 18.

membrane electrode assembly 13 includes a platy polymer electrolyte membrane (PEM) M and gas diffusion electrodes 11 and 12 holding both sides of the PEM M.

The PEM M corresponds to the polymer membrane, the gas diffusion electrodes 12 and 13 correspond to the conductive members, the induction and derivation member 14 of the electromagnetic wave corresponds to the electromagnetic wave induction member and the electromagnetic wave derivation member, the current collectors 15 and 16 correspond to the conductive member and the diffusion member, and the referential PEM Mr corresponds to the referential polymer membrane.

(The Polymer Electrolyte Membrane)

The PEM M uses well-known platy perfluorinated sulfonic acid membrane in the second embodiment.

The PEM M can use such as a hydrocarbon cation-exchange membrane or a bipolar membrane that has exchangeability of cation and anion besides the perfluorinated sulfonic acid membrane.

(The Gas Diffusion Electrode)

The gas diffusion electrodes 11 and 12 use platy conductive members. For example, the substrate of the gas diffusion electrodes 11 and 12 is carbon black and platinum particles are dispersively provided on the side facing to the PEM M as a catalytic activity material.

(The Induction and Derivation Member of the Electromagnetic Wave)

The induction and derivation member 14 of the electromagnetic wave uses a platy nonconductive member, and can let the electromagnetic wave penetrate the induction and derivation member 14 of the electromagnetic wave. And the induction and derivation member 14 of the electromagnetic wave preferably has appropriate elasticity. The elasticity can contact the MEA 13 with the current collectors 15 and 16 appropriately in assembling the cell 10 for measuring the water distribution in the polymer membrane, and can reduce the leak of the hydrogen or the oxygen which are supplied respectively via the housings 17 or 18.

The rectangular shaped through hole 14a is formed at the center of the induction and derivation member 14 of the electromagnetic wave. The MEA 13 formed by laminating the PEM M and the gas diffusion electrodes 11 and 12 is inserted in the through hole 14a.

The surface of the induction and derivation member 14 of the electromagnetic wave should have the size for the outside surface of the induction and derivation member 14 of the electromagnetic wave to be exposed from the outside surface of the cell 10 for measuring the water distribution in the polymer membrane. The electromagnetic wave can enter from the exposed outside surface, pass through the inside of the induction and derivation member 14 of the electromagnetic wave, and reach to the PEM M.

The thickness of the induction and derivation member 14 of the electromagnetic wave is preferably approximately the same as that of the MEA 13. This thickness can contact the induction and derivation member 14 of the electromagnetic wave with the current collectors 15 and 16 appropriately.

Therefore, the induction and derivation member 14 of the electromagnetic wave can use one selected from well-known materials in condition of previously explained. For example, the induction and derivation member 14 of the electromagnetic wave can use a silicon rubber sheet or a PTFE sheet.

(The Current Collector)

The current collectors 15 and 16 use platy members. The description of the current collector 15 will be given and the description of the current collector 16 will be omitted because they have the same shapes.

The current collector 15 uses, for example, a brass member. However, the current collector 15 can use other conductive members besides the brass member.

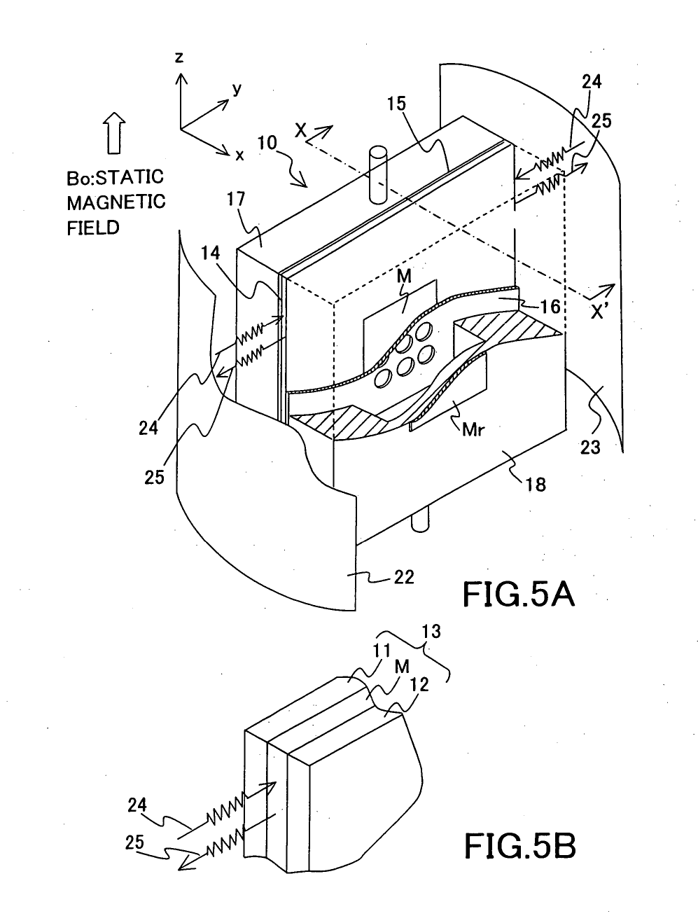

The current collector 15 is provided adjacently to the gas diffusion electrode 11 and connected to the external circuit 26 when being installed at the measurement part 20 of the apparatus (MRI apparatus) 100 for measuring the water distribution in the polymer membrane explained later. In generating the power, the electron generated at the gas diffusion electrode 11 of the fuel electrode side is guided to the external circuit 26 via the current collector 15 and is finally guided to the gas diffusion electrode 12 of the air electrode side via the current collector 16 (see FIGS. 5A, 6, and 7).

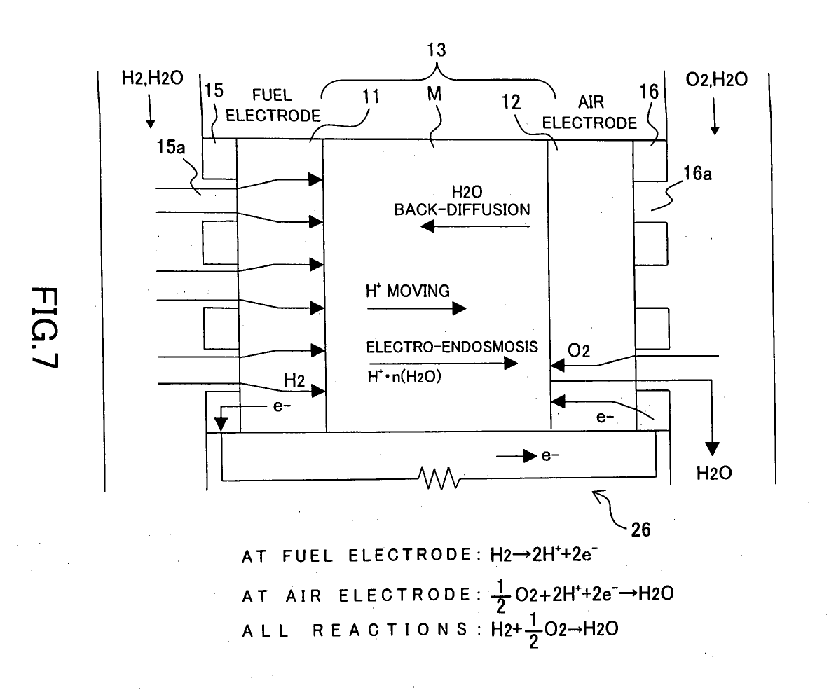

A plurality of the through holes 15a (for example, their sizes are φ 3 mm) are formed in the center of the current collector 15 at the contact part with the MEA 13 in assembling the cell 10 for measuring the water distribution in the polymer membrane. The hydrogen supplied from the housing 17's side can be supplied to the gas diffusion electrode 11 dispersively by flowing in the through hole 15a (see FIG. 7). The dispersed hydrogen is decomposed into the hydrogen ion and the electron by the platinum catalyst. The hydrogen ion can be supplied to the PEM M so that the concentration gradient of the hydrogen ion is even in the surface direction of the PEM M. Therefore, the water is distributed evenly in the surface direction of the PEM M, and the water distribution in the thickness direction (the x-direction shown in FIG. 5A) can preferably be measured.

(The Housing)

The housings 17 and 18 have gas flow paths for supplying the gas as a fluid from outside of the cell 10 for measuring the water distribution in the polymer membrane into the MEA 13 via its both sides. The description of the housing 17 will be given and the description of the housing 18 will be omitted because they have the same shapes.

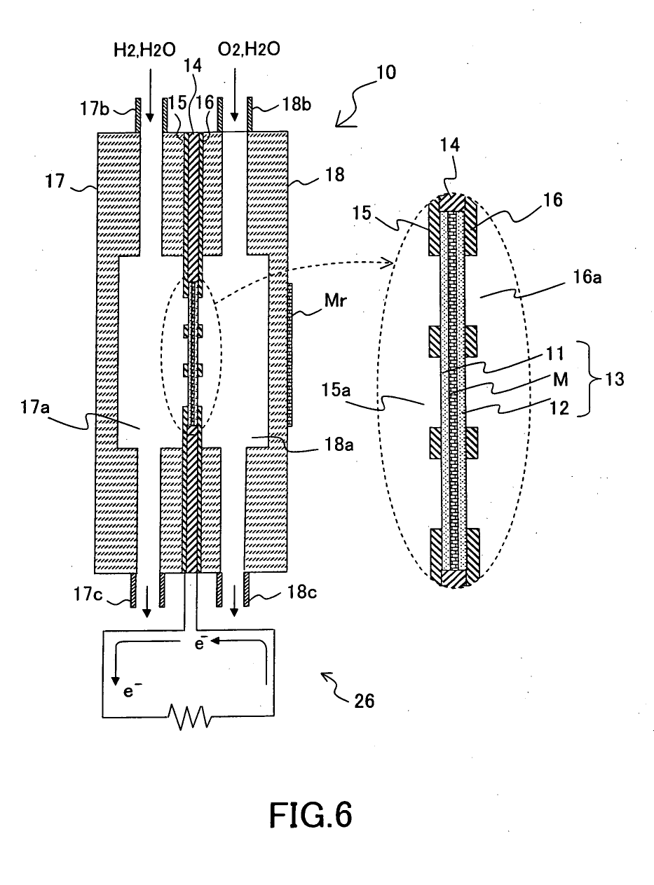

The gas flow path formed in the housing 17 includes a gas chamber 17a, a gas intake part 17b, and a gas outlet part 17c as shown in FIG. 6.

The gas chamber 17a is a concave part of the housing 17 which is provided at the PEM M's side. The size of the gas chamber 17a is more than that of the area where the plurality of the through holes 15a of the current collector 15 is formed. The gas chamber 17a can supply the gas to whole the plurality of the through holes 15a.

The gas intake part 17b is a path for taking the gas from outside of the cell 10 for measuring the water distribution in the polymer membrane into the gas chamber 17a.

The gas outlet part 17a is a path for exhausting the gas from the gas chamber 17a to outside of the cell 10 for measuring the water distribution in the polymer membrane.

Preferably, the housing 17 uses a nonconductive material. Then, the cell 10 can barely be influenced from the applied static magnetic field Bo when being installed in the measuring part 20 of the apparatus 100 for measuring the water distribution in the polymer membrane which will be explained later.

Therefore, the housing 17 of the present invention can use any one selected from well-known materials according to the previously explained conditions, and such as acrylic resin.

(The Referential Polymer Electrolyte Membrane)

The referential polymer electrolyte membrane (the referential PEM) Mr has the same material as the PEM M explained before, and is provided on the outside of the housing 18 appropriately. Providing the referential PEM Mr besides the PEM M that reacts and changes its water distribution in generating the power with the same initial conditions (for example, the water content) as the PEM M can make a comparison between the referential PEM Mr and the PEM M in the generating reaction.

The referential PEM Mr is preferably located in parallel with the PEM M. Then, both of the referential PEM Mr and the PEM M can be irradiated by the electromagnetic wave 24 simultaneously when the cell 10 is installed in the measuring part 20 of the apparatus 100 for measuring the water distribution in the polymer membrane which will be explained later (see FIG. 5A).

The description of the operations and effects on the cell for measuring the water distribution in the polymer membrane according to the second embodiment will be follow.

The laminated MEA 13 is formed by holding the PEM M on its both sides by the gas diffusion electrodes 11 and 12, and is inserted to the through hole 14a of the induction and derivation member 14 of the electromagnetic wave. The cell 10 for measuring the. water distribution in the polymer membrane is assembled by holding the outsides of the induction and derivation member 14 of the electromagnetic wave by the current collectors 15 and 16, holding the outside of the current collectors 15 and 16 by the housings 17 and 18, and providing the referential PEM Mr on the outside surface of the housing 18.

By installing the cell 10 for measuring the water distribution in the polymer membrane in an appropriate direction in, for example, the MRI apparatus that includes the electromagnetic wave emitter, the electromagnetic wave emitted from the electromagnetic wave emitter can penetrate the inside of the induction and derivation member 14 of the electromagnetic wave, reach to the inside of the PEM M, and make the hydrogen of the water in the PEM M be resonant.

After the emission, the electromagnetic wave radiated from resonant hydrogen of the water can be delivered to outside by passing through the inside of the induction and derivation member 14 of the electromagnetic wave. The PEM M can be compared with the referential PEM Mr by providing the referential PEM Mr out of the reaction system.

[The Third Embodiment]

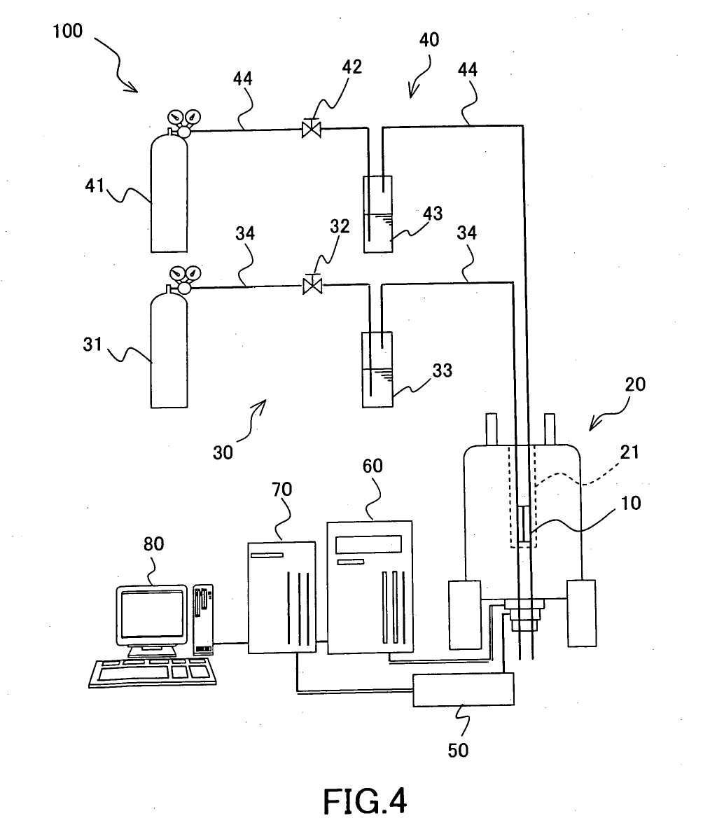

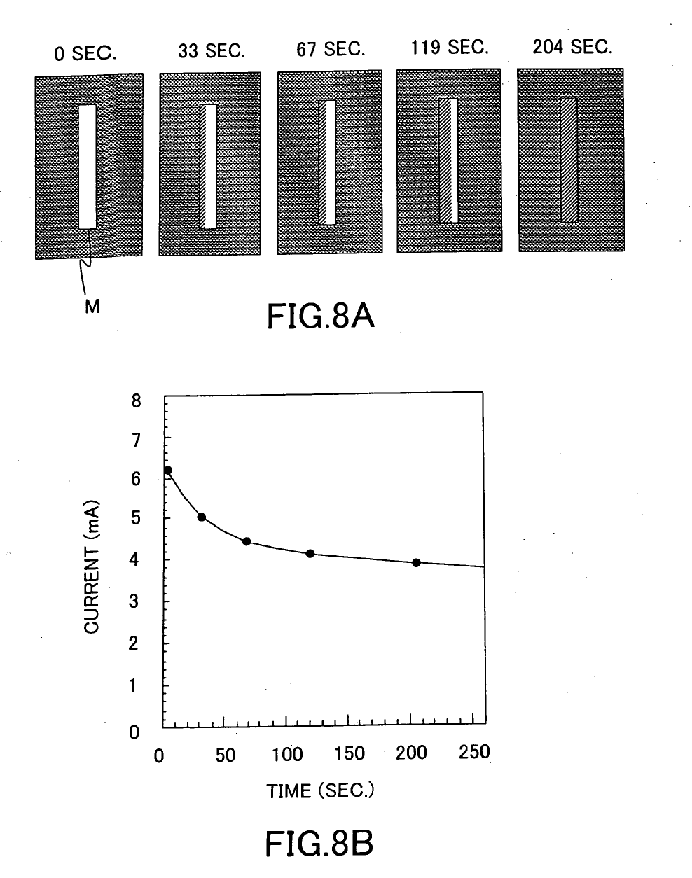

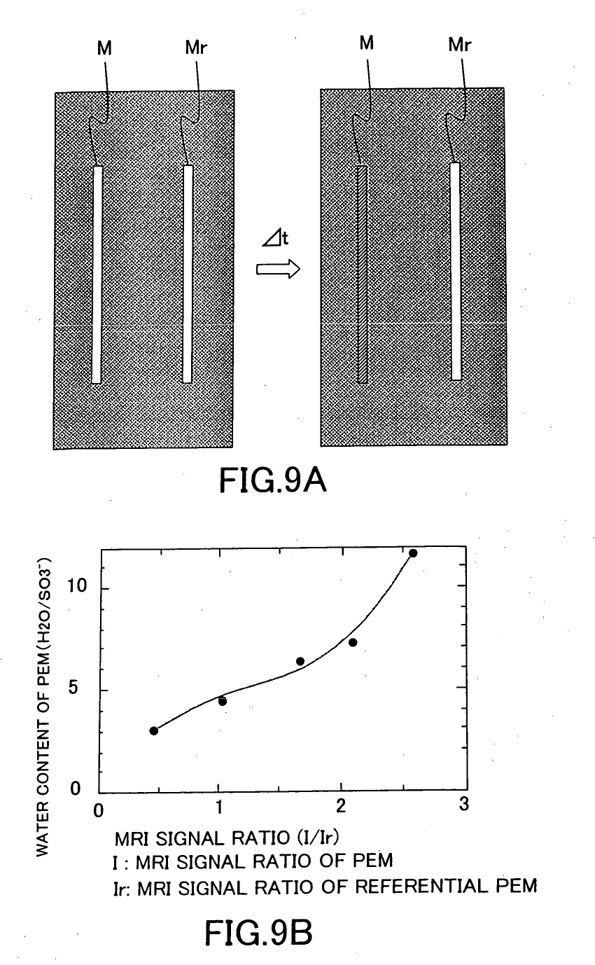

The description will be given of an apparatus 100 for measuring the water distribution in the polymer membrane of the third embodiment according to the present invention with referring FIGS. 4. to 9. FIG. 4 is a general view showing the arrangement of the apparatus 100 for measuring the water distribution in the polymer membrane of the third embodiment according to the present invention. FIG. 5A and 5B are views showing the principle part of the apparatus 100 for measuring the water distribution in the polymer membrane of the third embodiment shown in FIG. 4. FIG. 6 is a X-X′ sectional view of the principle part of the apparatus 100 for measuring the water distribution in the polymer membrane of the third embodiment shown in FIG. 5A. FIG. 7 is a view explaining the state of the water distribution in the polymer membrane measured by the apparatus 100 for measuring the water distribution in the polymer membrane of the third embodiment. FIG. 8A is a schematic view showing the aging change of the MRI image of the polymer electrolyte membrane (polymer membrane). FIG. 8B is a graph showing the aging change of the current that runs in the external circuit of the apparatus 100 for measuring the water distribution in the polymer membrane in accordance with the aging change shown in FIG. 8A. FIG. 9A is a schematic view showing the MRI images of the polymer electrolyte membrane (polymer membrane) and the referential polymer electrolyte membrane (referential polymer membrane) before generating the power and on generating the power. FIG. 9B is a graph showing the MRI signal intensity vs. water content in the polymer electrolyte membrane (polymer membrane) and the referential polymer electrolyte membrane (referential polymer membrane). The x, y and z axes being perpendicular to each other are shown in FIG. 5A.

The apparatus 100 is for measuring the water distribution in the PEM (the polymer membrane) that belongs to the cell 10.

As shown in FIG. 4, the apparatus 100 for measuring the water distribution in the polymer membrane includes the cell 10 for measuring the water distribution in the polymer membrane and the measuring part 20 where the cell 10 is installed in as a principle part. The apparatus 100 further includes a hydrogen supplying part 30, an oxygen supplying part 40, an amplifier 50, a gradient magnetic field generator 60, a NMR console 70, and a microcomputer 80.

Here, the measuring part 20, the amplifier 50, the gradient magnetic field generating unit 60, the NMR console 70, and the microcomputer 80 can respectively use one selected appropriately from the MRI apparatus which is well known, and can use for example “Unity INOVA300 (Varian Inc.) ” which has the staticmagnetic field as 7.05 [T].

(The Measuring Part)

The measuring part 20 includes the cell 10 for measuring the water distribution in the polymer membrane, an installing part 21 for installing the cell 10, a static magnetic field generating coil (not shown), a gradient magnetic field generating coil (not shown), and facing RF coils 22 and 23 (see FIGS. 4 and 5A).

The static magnetic field generating coil (not shown) corresponds to the static magnetic field generator, the gradient magnetic field generating coil (not shown) and the gradient magnetic field generating unit 60 correspond to the gradient magnetic field generator, and the facing RF coils 22 and 23 correspond to the electromagnetic wave emitter, the electromagnetic wave detector, or the converter.

The installing part 21 has a approximately cylindrical concave portion that is open upward, and can install the cell 10 for measuring the water distribution in the polymer membrane detachably from the open part.

The static magnetic field generating coil (not shown) is for generating the static magnetic field Bo in z-direction as shown in FIG. 5A, and can use one appropriately selected from the superconductive coil, the permanent magnet and the like which are well known. The superconductive coil is preferable because it can generate the static magnetic field Bo strongly and can improve sensitivity of the measurement.

The gradient magnetic field generating coil (not shown) includes a x-direction gradient magnetic field generating coil (not shown), a y-direction gradient magnetic field generating coil (not shown), and a z-direction gradient magnetic field generating coil (not shown) which are the same as in the first embodiment. The coils can generate the gradient magnetic fields graded along the x-direction, the y-direction, and the z-direction shown in FIG. 5A respectively.

The RF coils 22 and 23 are well known and generally called as “saddle coils”. They are installed facing with each other and can emit the electromagnetic waves 24 and 24 facing with each other along the y-axis direction. The RF coils can further detect the electromagnetic waves 25 and 25 (also called as “the signals”) radiated from the cell 10 for measuring the polymer membrane (as the electromagnetic wave detector) after the emission of the electromagnetic waves 24 and 24, and can convert the electromagnetic waves 25 and 25 into the MRI signal (also called as “the NMR signal”) as the converter.

The cell 10 for measuring the water distribution in the polymer membrane is installed in the middle between the RF coils 22 and 23 as the same as in the second embodiment. The cell 10 is arranged so that the emitting direction of the electromagnetic waves 24 and 24 emitted from the RF coils 22 and 23 (the y-axis direction) will be in parallel to the direction which the surface of the induction and derivation member 14 of the electromagnetic wave, the MEA 13, or the PEM M spreads. Therefore, the electromagnetic waves 24 and 24 can penetrate the induction and derivation member 14 of the electromagnetic wave appropriately (see FIG. 5A), reach to the inside of the PEM M via its sidewall, and make the hydrogen of the water be resonant (see FIG. 5B). More, the electromagnetic waves 25 and 25 radiated from resonant hydrogen after the emission of the electromagnetic waves 24 and 24 can be radiated to the outside of the cell 10 for measuring the water distribution in the polymer membrane by passing through the sidewall of the PEM M and the inside of the induction and derivation member 14 of the electromagnetic wave (see FIGS. 5A and 5B).

The arrangement of the emitting direction of the electromagnetic waves 24 and 24 and the direction which the surface of the PEM M spreads is not limited precisely in parallel. They may be arranged so that the electromagnetic waves 24 and 24 can reach to the PEM M by penetrating the induction and derivation member 14 of the cell 10.

To emit the electromagnetic waves 24 and 24 from both sides of the cell 10 by using the RF coils 22 and 23 can make the hydrogen in the PEM M be resonant effectively and the sensitivity of the measurement can be improved.

The current collectors 15 and 16 of the cell 10 are connected to the external circuit 26 as shown in FIGS. 6 and 7.

(The Hydrogen Supplying Part)

The hydrogen supplying part 30 includes in turn from upstream a hydrogen tank 31 that storages the hydrogen as a fuel, a bulb 32 for adjusting the flow of the hydrogen gas, and a water tank 33 for moisturizing the hydrogen gas by bubbling method that is well known. The hydrogen supplying part 30 is connected to the measuring part 20 via connecting pipes 34 and 34 and can supply the hydrogen to the gas chamber 17a via the gas intake part 17b of the housing 17 that belongs to the cell 10 installed in the measuring part 20. The gas outlet part 17c can exhaust the surplus hydrogen gas to the outside of the measuring part 20 by being connected to the outside of the measuring part 20 appropriately.

(The Oxygen Supplying Part)

The oxygen supplying part 40 includes in turn from upstream an oxygen tank 41 that storages the oxygen, a bulb 42 for adjusting the flow of the oxygen gas, and a water tank 43 for moisturizing the oxygen gas. The oxygen supplying part 40 is connected to the measuring part 20 via connecting pipes 44 and 44 and can supply the oxygen to the gas chamber 18a via the gas intake part 18b of the housing 18 that belongs to the cell 10 installed in the measuring part 20. The gas outlet part 18c can exhaust the surplus oxygen gas to the outside of the measuring part 20 by being connected to the outside of the measuring part 20 appropriately.

(The Amplifier)

The amplifier 50 includes a circuit to amplify or attenuate the electric signal, and amplifies and/or attenuates the MRI signal. The amplifier 50 is connected to the RF coils 22 and 23 in the measuring part 20 and the NMR console 70.

(The Gradient Magnetic Field Generating Unit)

The gradient magnetic field generating unit 60 includes a bulk power supply unit, and controls the gradient magnetic field generated by the gradient magnetic field generating coil (not shown). The gradient magnetic field generating unit 60 is connected to the gradient magnetic field generating coil in the measuring part 20 and the NMR console 70.

(The NMR Console)

The NMR console 70 including a NMR spectrometer transmits and receives the MRI signal and analyzes the received signal. The NMR console is connected to the amplifier 50, the gradient magnetic field generating unit 60, and the microcomputer 80.

(The Microcomputer)

The microcomputer 80 used in the third embodiment is well-known one, analyzes the MRI signal intensity converted by the RF coils 22 and 23, and generates and outputs the MRI image according to the analysis. The microcomputer 80 corresponds to the image processor.

The description of the operations and effects on the apparatus 100 for measuring the water distribution in the polymer membrane according to the third embodiment will be follow.

First of all, the measuring part 20, the amplifier 50, the gradient magnetic field generating unit 60, the NMR console, and the microcomputer 80 are started. Then, a specific amount of the hydrogen gas and the oxygen gas are supplied to the cell 10 for measuring the water distribution in the polymer membrane by adjusting the bulb 32 and the bulb 42.

Thus, the power generating has begun in the cell 10. The detail description of the generating will be follow with referring. to FIG. 7.

At the fuel electrode side, the hydrogen is dispersively supplied to the gas diffusion electrode 11 by passing through the plurality of the through holes 15a of the current collector 15. The dispersed hydrogen diffuses in the gas diffusion electrode 11 with permeation, and is decomposed to the hydrogen ion and the electron e- by the platinum catalyst (not shown) provided on the PEM M side of the gas diffusion electrode 11. The electron is guided to the external circuit 26 via the current collector 15 and moves in the external circuit 26 to the current collector 16 in the air electrode side. The hydrogen ion generated by decomposition moves in the hydrophilic cluster of the PEM M from the fuel electrode side to the air electrode side along with the water molecule hydrated to the hydrogen ion.

Meanwhile at the air electrode side, the oxygen is dispersively supplied to the gas diffusion electrode 12 bypassing through the plurality of the through holes 16a of the current collector16. The dispersed oxygen diffuses in the gas diffusion electrode 12 with permeation, and generates the water in the PEM M side by reacting with the hydrogen ion and the electron.

In the PEM M, the back diffusion of the water, the evaporation of the water or the like also occurs in accordance with the distribution state of the generated water.

In the power generating state that causes the concentration gradient of the water (the uneven distribution of the water) in the PEM M, the water distribution has been measured by using well-known Pulsed Field Gradient Method with setting the hydrogen atom of the water or of the sulfonic acid radical in the PEM M as a measuring nucleus.

The NMR signal from the atomic nucleus is received with mixing the x, y, z-position information by the gradient magnetic field of the x, y, z-directions after exciting the atomic nucleus by the electromagnetic wave, and the density of the atomic nucleus or the state of the chemical bonding can be imaged in a specific section with using the GRADIENT MAGNETIC FIELD METHOD.

As shown in FIG. 5A, the static magnetic field Bo and the gradient magnetic field from 3-dimensional direction are applied to the PEM M of the cell 10 for measuring the water distribution in the polymer membrane. Thus, the hydrogen in the PEM M has the position information. After that, the electromagnetic waves 24 and 24 emitted from the RF coils 22 and 23 penetrate the induction and derivation member 14 of the electromagnetic wave, irradiate the hydrogen that has the position information, and make the hydrogen be resonant.

To emit the electromagnetic waves 24 and 24 repeatedly can strength the resonance and improve the sensitivity of the measurement.

After stopping the emission of the electromagnetic waves 24 and 24, the electromagnetic waves 25 and 25 are radiated from the resonant hydrogen while the hydrogen is becoming stable state. The electromagnetic waves 25 and 25 are radiated via the sidewall of the PEM M as shown in FIG. 5B, passes through the inside of the induction and derivation member 14 of the electromagnetic wave and radiated to the outside of the cell 10 (see FIG. 5A). Then, the electromagnetic waves 25 and 25 are detected and converted to the MRI signal by the RF coils 22 and 23.

The MRI signal will be transmitted to the microcomputer 80.

The microcomputer 80 processes the image analysis in accordance with the transmitted MRI signal, and generates and outputs the MRI image. The water distribution in the PEM M can be recognized simultaneously in power generating by observing the MRI image.

The operator can freely select the section of the MRI image in 3-dimension. Thus, the water distribution in 3-dimension in the PEM M can be measured.

The description of the obtained MRI image will be following with referring to FIG. 8A.

Each drawing in FIG. 8A shows a sectional view of the PEM Min its thickness direction (the x-directionas shown in FIG. 5A). The left-side of each drawing is the fuel electrode side, and the right-side is the air electrode side. The 45 hatching area corresponds to the area where the MRI image cannot be obtained, and the non-hatching area corresponds to the area where the MRI image can be obtained.

Right after the beginning of the power generating, the MRI image can be obtained at whole area as shown in FIG. 8A (0[sec.]) The area where the MRI image cannot be obtained gradually increases from the fuel electrode side toward the air electrode side along with the passage of power generating time. Because the water near the fuel electrode disappears along with the passage of power generating time.

Thus, it is confirmed that the water concentration is formed to be thicker near the air electrode side by the decrease of the water near the fuel electrode side along with the passage of power generating time.

FIG. 8B shows the measurement results of the current that flows in the external circuit 26 in accordance with the MRI image shown in FIG. 8A.

As shown in FIGS. 8B and 8A, the current decreases in accordance with the decrease of the water content in the PEM M. Because the resistance of the PEMM increases and the hydrogen ion in the PEM M can barely move in accordance with the decrease of the water content in the PEM M.

(The Comparison with the Referential PEM)

The description will be given of a method to quantify the water content in the PEM M by comparing the PEM M and the referential PEM Mr.

As shown in left side drawing in FIG. 8A, the MRI image of the PEM M is the same as that of the referential PEM Mr before power generation, when their initial conditions (such as the water content) are the same.

Here, FIG. 8A is a schematic view of the MRI image sectioned along the x-direction shown in FIG. 5A, that is, the thickness direction of the PEM M or the referential PEM Mr After beginning of the power generating (At[sec.]), the MRI image of the PEMM cannot be obtained according to the decrease of the water and dry of the PEM M as shown in right side drawing in FIG. 8A. Meanwhile, the MRI image which is same as before power generation of the referential PEM Mr arranged outside of the reaction system can be still obtained.

The water content is estimated by measuring the weight of the referential PEM Mr by the electronic weighting scale. And the MRI image of the cell 10 that includes the referential PEM Mr whose water content has been estimated and the PEM M is obtained.

Then, the MRI images of the cell 10 that includes the referential PEM Mr whose water content has been estimated and the PEM M are obtained with changing the water content of the PEM M. Then, the relation between the MRI signal intensity ratio of the PEM M and the referential PEM Mr, and the water content in the PEM M is shown in FIG. 9B as a graph.

To estimate the water content in the PEM M of the cell 10 in generating the power according to the time passage, the MRI signal intensity ratio of the referential PEM Mr provided on the sidewall of the cell 10 and the PEM M should be measured. And the water content in the PEM M is quantified by using the graph shown in FIG. 9B which is produced in advance.

### THE EXAMPLE

The description of the example according to the present invention will be following.

The MRI apparatus uses “Unity INOVA300 (Varian Inc.) ” which has the static magnetic field as 7.05 [T]. The intensity of the static magnetic field Bo is set on 7.05 [T], the intensity of the maximum gradient magnetic field is set on 24 [gauss] (2.4 [mT/cm]), and the frequency of the electromagnetic waves emitted from the RF coils is set on 300 [MHz].

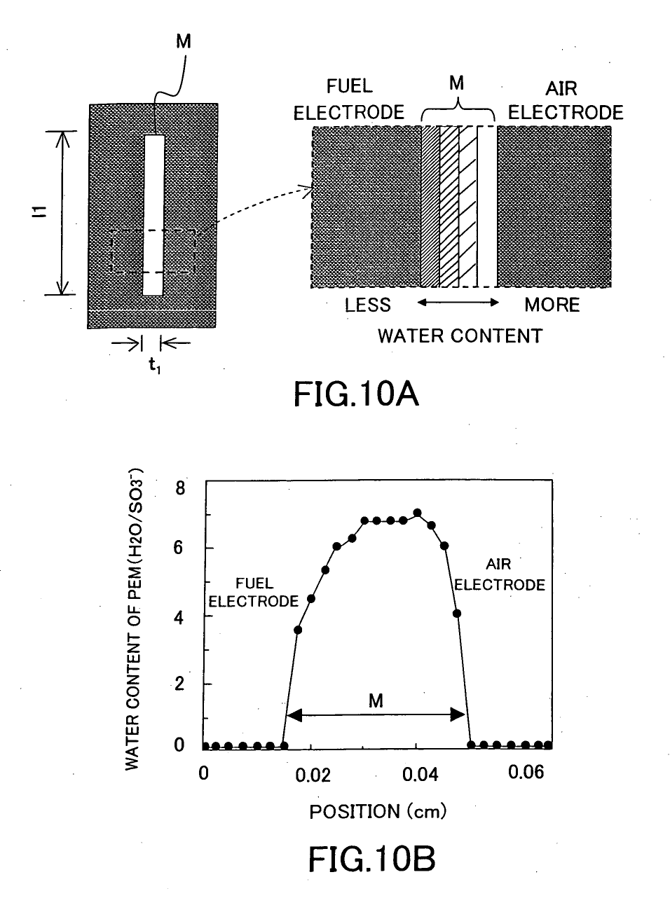

The PEM M uses a perfluorinated sulfonic acid membrane which is a square of one side length (11) as 14 [mm], and has a thickness (t1) of 340 [μm] as shown in FIG. 10A. The density of the platinum provided on the gas diffusion electrodes 11 and 12 is 0.5 [mg/cm²].

The flow of the oxygen is set on 456 [ml/min.] and the flow of the hydrogen is set on 60 [ml/min.]. Only the oxygen is moisturized.

A variable resistor (not shown) provided in the external circuit 26 appropriately controls the state of the power generation in the cell 10.

Well-known SPIN ECHO METHOD is used for the measurement. The MRI image is 16 times accumulated with 128 [pixels]×256 [pixels].

The measurement results will be described with referring to FIGS. 10A and 10B.

FIG. 10A is a schematic view of the MRI image of the polymer electrolyte membrane M. The fuel electrode is left-hand and the air electrode is right-hand. Longer line-to-line distance of the 45° hatching indicates more water content and shorter line-to-line distance of that indicates less water content. FIG. 10A shows the water content is less near the fuel electrode side and more near the air electrode side in the PEM M and the water distribution is uneven.

FIG. 10B is a graph showing the number of the water molecules per a sulfonic acid radical in the thickness direction of the polymer electrolyte membrane M. The number of the water molecules is calculated by using the MRI signal intensity ratio of the PEM M and the referential PEM Mr and the graph line shown in FIG. 9B.

FIG. 10B shows the water content is more near the air electrode side and uneven in the PEM M

[The Variation]

Further, the present invention is not limited to these preferred embodiments. Various variations and modifications may be made without departing from the scope of the present invention. Following is a description about one of the variations.

The facing RF coils 6a and 6b or 22 and 23 emit the electromagnetic waves from both sides of the polymer membrane in the first or the third embodiment. However as another example, one solenoid type RF coil may emit the electromagnetic wave from one side of the polymer membrane. Or, the solenoid type RF coil may be arranged so that its roll center is along the z-direction and the RF coil surrounds the cell 10 (or the container 1) when the static magnetic field is along the y-direction.

The induction and derivation member 14 of the electromagnetic wave corresponds to the electromagnetic wave induction member and the electromagnetic wave derivation member in the second embodiment. However as another example, the electromagnetic induction member and the electromagnetic wave derivation member may be provided respectively. If the possibility of the hydrogen or oxygen leakage is allowable, it is not necessary to provide the induction and derivation member. The electromagnetic wave can enter into the PEM M directly from exposed sidewall of the PEM M without the induction and derivation member 14 of the electromagnetic wave (claim 3).

The MEA 13 is inserted in the induction and derivation member 14 of the electromagnetic wave and the induction and derivation member 14 of the electromagnetic wave is exposed to outside surface of the cell 10 in every direction which the surface of the member 14 spreads in the second embodiment. However as another example, an induction and derivation member of the electromagnetic wave made of nonconductive material may be arranged in a channel formed on the housing 17 toward the PEM M when the PEM M is inserted in a concave portion formed on the housing 17.

The plurality of the through holes 15a and 16a are formed on the conductive current collectors 15 and 16 as the diffusion members in the second embodiment. However as another example, a nonconductive diffusion member may be provided besides the current collectors.

The current collectors 15 and 16 including the through holes 15a and 16a is provided adjacent to the MEA 13 in the cell 10 of the second embodiment. However as another example, a conductive mesh element may further be provided between the current collectors 15, 16 and the MEA 13. The hydrogen and the oxygen can be supplied more dispersively and evenly to the gas diffusion electrodes by passing through the mesh element.

The cell 10 for measuring the water distribution in the polymer membrane is applied to the MEA 13 of the PEFC in the second embodiment. However as another example, silver-silver chloride electrodes or the like can be used instead of the gas diffusion electrodes 11 and 12 to measure the water distribution in the polymer membrane held by the electrodes in electro-endosmosis by the electric field generated by the electrodes.

The cell 10 for measuring the water distribution in the polymer membrane is applied to the PEFC and uses such as the perfluorinated sulfonic acid membrane. However, the cell 10 may use such as an anion exchange resin including quaternary ammonium compound when it is applied in measuring the water hydrated to the ion that moves in the polymer membrane held by the electrodes in the electro-endosmosis by applying the electric field to the polymer membrane.

The cell 10 for measuring the water distribution in the polymer membrane according to the present invention is applied to the PEFC, and the hydrogen and the oxygen are supplied into the gas chambers 17a and 18a of the housings 17 and 18 in the third embodiment. However as another example, the water may be supplied to the housings 17 and 18 in measuring the water distribution in the polymer membrane in the electro-endosmosis.

The water content in the PEM M is estimated from the MRI signal intensity ratio of the PEM M and the referential PEM Mr in the third embodiment. However as another example, the water content may be estimated from the chemical shift, the diffusion coefficient, the MRI signal intensity, or the like of each MRI image by obtaining the chemical shift image, the diffusion exaggeration image, the T2 exaggeration image, or the like.

The moisturized (i.e., the water containing) hydrogen is supplied to the housing part of the cell 10 in the third embodiment. However as another example, a diffusion area in the PEM M can be detected by obtaining the MRI image of the PEM M with supplying the deuterium instead of the hydrogen and the deuterium oxide instead of the water.

The electromagnetic waves 24 and 24 are emitted from the RF coils 22 and 23 by using well-known SPIN ECHO METHOD in the third embodiment. However as another example, CHEMICAL SHIFT IMAGING METHOD, DIFFUSION IMAGING METHOD, or CONSTANT TIME IMAGING METHOD can be used. CHEMICAL SHIFT IMAGING METHOD replaces the water content in the PEM M as the MRI signal intensity, and can process the measurement without using the referential PEM Mr. DIFFUSION IMAGING METHOD can estimate the water concentration distribution because of the dependency of the self-diffusion coefficient on the water content. CONSTANT TIME IMAGING METHOD can measure the water concentration distribution in 3-dimension with higher resolution.

Further, the present invention is not limited to these preferred embodiments. Various variations and modifications may be made without departing from the scope of the present invention.

The present invention has the superior effects as described below. According to the invention disclosed in claim 1, the water distribution between the conductive members can be measured spatially (3-dimensionally) by emitting the electromagnetic wave to the hydrogen molecular of the water along a direction which a gap formed by the conductive members spreads.

According to the invention disclosed in claim 2, the cell for measuring the water distribution in the PEM can make hydrogen of the water in the PEM resonate with the electromagnetic wave in accordance with the reach of the electromagnetic wave from outside into the inside of the PEM by passing through the electromagnetic induction member by installing the cell for measuring the water distribution in the PEM in an appropriate direction to the electromagnetic wave emitted from the electromagnetic wave emitter that includes such as a RF coil of the MRI apparatus. After the emission of the electromagnetic wave from outside to the PEM, the electromagnetic wave radiated from the resonant hydrogen is delivered to outside via the electromagnetic derivation member and is detected by the electromagnetic wave detector that includes such as the RF coil of the MRI apparatus. Thus, the water distribution in the PEM can be measured.

According to the invention disclosed in claim 3, the cell for measuring the water distribution in the PEM can make hydrogen of the water in the PEM resonate with the electromagnetic wave in accordance with the reach of the electromagnetic wave from outside into the inside of the PEM by installing the exposed part of the sidewall of the PEM in an appropriate direction to the irradiation direction of the electromagnetic wave emitted from the electromagnetic wave emitter that includes such as a RF coil of the MRI apparatus. After the emission of the electromagnetic wave to the PEM, the electromagnetic wave radiated from the hydrogen is radiated to outside via the exposed part of the PEM's sidewall and is detected by the electromagnetic wave detector that includes such as the RF coil of the MRI apparatus. Thus, the water distribution in the PEM can be measured.

According to the invention disclosed in claim 4, the liquid is supplied with dispersion to the PEM via the plurality of the through holes of the diffusion members. Therefore, the concentration distribution of the liquid is hardly produced in the direction of the PEM's surface and the water distribution in the PEM will be measured suitably.

According to the invention disclosed in claim 5, the polymer membrane can be compared with the referential polymer membrane in measuring the water distribution in the polymer membrane by providing the cell on the MRI apparatus.

According to the invention disclosed in claim 6, the apparatus for measuring the water distribution in the polymer membrane can apply the static magnetic field and the gradient magnetic field in the water in the polymer membrane, emit the electromagnetic wave, and make the hydrogen in the water be resonant. And after emitting the electromagnetic wave, the apparatus for measuring the water distribution in the polymer membrane can detect the electromagnetic wave radiated from the resonant hydrogen by the electromagnetic wave detector, convert the electromagnetic wave to the electric signal. The apparatus for measuring the water distribution in the polymer membrane can further generate and output an MRI image according to the electric signal, and the operator of the apparatus can recognize the water distribution in the polymer membrane in view.

Thus, by analyzing and recognizing the water distribution in the polymer membrane precisely, the polymer membrane such as a polymer electrolyte membrane that is used for the fuel battery can be researched and developed appropriately.

1. A method for measuring a water distribution between two platy conductive members that are arranged so as to face each other by using a MRI apparatus,
said method comprising a step of measuring the water distribution between said two platy conductive members by irradiating the water by an electromagnetic wave along a direction which a gap formed by said two platy conductive members spreads.

2. A cell for measuring a water distribution in a polymer membrane, said cell being applied to a MRI apparatus comprising:
a platy polymer membrane that contains a water, conductive members that hold each side of the polymer membrane,
an electromagnetic wave induction member that is arranged adjacently to the polymer membrane and can be passed by an electromagnetic wave emitted from outside through to the polymer membrane; and
an electromagnetic wave derivation member that is arranged adjacently to the polymer membrane and can be passed by an electromagnetic wave radiated from the polymer membrane after the emission through to outside.

3. A cell for measuring a water distribution in a polymer membrane, said cell being applied to a MRI apparatus comprising:
a platy polymer membrane that contains a water; and
conductive members that hold each side of the polymer membrane,
wherein at least a part of a sidewall of the polymer membrane is exposed to outside,
wherein an electromagnetic wave emitted from outside can reach inside of the polymer membrane by entering from the part of the sidewall,
wherein an electromagnetic wave is radiated from the polymer membrane after the emission toward outside through the part of the sidewall.

4. The cell according to claim 2, wherein diffusion members that have a plurality of through holes are provided to both sides of the polymer membrane, and a fluid from outside can be supplied to the polymer membrane with diffusing via the plurality of the through holes.

5. The cell according to claim 2, wherein a referential polymer membrane that uses the same material as said polymer membrane is provided to the polymer membrane cell.

6. An apparatus for measuring a water distribution in a polymer membrane comprising:
a polymer membrane cell for measuring the water distribution being applied to a MRI apparatus, which includes a platy polymer membrane that contains a water, conductive members that hold each side of the polymer membrane, an electromagnetic wave induction member that is arranged adjacently to the polymer membrane and can be passed by an electromagnetic wave emitted from outside through to the polymer membrane, and an electromagnetic wave derivation member that is arranged adjacently to the polymer membrane and can be passed by an electromagnetic wave radiated from the polymer membrane after the emission through to outside,
a static magnetic field generator that generates a static magnetic field and applies the static magnetic field to the polymer membrane,
a gradient magnetic field generator that generates a gradient magnetic field and applies the gradient magnetic field to the polymer membrane, an electromagnetic wave emitter to emit an electromagnetic wave to the polymer membrane,
an electromagnetic wave detector to detect a electromagnetic wave radiated from the polymer membrane after the emission,
a converter to convert the detected electromagnetic wave to an electric signal; and
an image processor to process an image according to the electric signal,
wherein the polymer membrane cell for measuring the water distribution is arranged along both directions that the electromagnetic wave emitted from the electromagnetic wave emitter can reach to the polymer membrane and the electromagnetic wave radiated from the polymer membrane can reach to the electromagnetic wave detector.

7. The cell for measuring a water distribution according to claim 3, wherein diffusion members that have a plurality of a through holes are provided to both sides of the polymer membrane, and a fluid from outside can be supplied to the polymer membrane with diffusing via the plurality of the through holes.

8. The cell according to claim 3, wherein a referential polymer membrane that uses the same material as said polymer membrane is provided to the polymer membrane cell.

9. An apparatus for measuring a water distribution in a polymer membrane comprising:
a polymer membrane cell for measuring a water distribution being applied to a MRI apparatus, which includes a platy polymer membrane that contains a water and conductive members that hold each side of the polymer membrane, wherein at least a part of a sidewall of the polymer membrane is exposed to outside, wherein an electromagnetic wave emitted from outside can reach inside of the polymer membrane by entering from the part of the sidewall, wherein an electromagnetic wave is radiated from the polymer membrane after the emission toward outside through the part of the sidewall,
a static magnetic field generator that generates a static magnetic field and applies the static magnetic field to the polymer membrane,
a gradient magnetic field generator that generates a gradient magnetic field and applies the gradient magnetic field to the polymer membrane,
an electromagnetic wave emitter to emit an electromagnetic wave to the polymer membrane,
an electromagnetic wave detector to detect a electromagnetic wave radiated from the polymer membrane after the emission,
a converter to convert the detected electromagnetic wave to an electric signal; and
an image processor to process an image according to the electric signal,
wherein the polymer membrane cell for measuring the water distribution is arranged along both directions that the electromagnetic wave emitted from the electromagnetic wave emitter can reach to the polymer membrane and the electromagnetic wave radiated from the polymer membrane can reach to the electromagnetic wave detector.
